(19) United States
(12) Patent Application Publication
(10) Pub. No.: US 2012/0190321 A1
(43) Pub. Date: Jul. 26, 2012

(54) NONMAGNETIC STAINLESS STEEL, MEMBER FOR RADIO-CONTROLLED TIMEPIECE, PRODUCTION PROCESS OF NONMAGNETIC STAINLESS STEEL AND RADIO WAVE RECEIVER

(75) Inventors: Junichi Sato, Hamura (JP); Toshihiro Uehara, Yasugi (JP); Kenji Yokoyama, Yasugi (JP)

(73) Assignees: HITACHI METALS, LTD., Tokyo (JP); CASIO COMPUTER CO., LTD., Tokyo (JP)

(21) Appl. No.: 13/387,599

(22) PCT Filed: Jul. 29, 2010
(86) PCT No.: PCT/JP2010/062766

§ 371 Date: Apr. 6, 2012

(30) Foreign Application Priority Data
Aug. 3, 2009 (JP) 2009-180905

(51) Int. Cl. H04B 1/08; C22C 38/42; G04B 37/00; C22C 30/02; C21D 8/00; C22C 38/34; C22C 38/40; C22C 30/00

(52) U.S. Cl. 455/269; 420/50; 420/49; 420/586.1; 420/582; 148/608; 148/707; 368/280

(57) ABSTRACT

A nonmagnetic stainless steel which has a higher electrical resistivity than existing nonmagnetic alloys, a production process for producing the stainless steel, and a radio wave receiver.

The receiver has a main case and rear cover constituted of a nonmagnetic stainless steel having an electrical resistivity as high as more than 100 μΩ·cm and consisting of C: not more than 0.1%, Si: 4.0-7.5%, Mn: not more than 2.0%, Ni: 25.5-30.0%, Cr: 15.0-20.0%, Mo: 0.1-3.0%, Cu: 0-2.0%, in mass % and the balance Fe and impurities. Even if some variable magnetic flux generated by a coil of an antenna runs through the main case and the rear cover, the receiving efficiency of the antenna can be prevented from being reduced by eddy current loss and a sufficient radio receiving sensitivity can be obtained. This nonmagnetic stainless steel is produced by hot and/or cold plastic working and subsequent solution treating conducted at 1,000-1,180° C.

### TECHNICAL FIELD

The present invention relates to a nonmagnetic stainless steel having a high electrical resistivity, a member for radio-controlled timepiece using this nonmagnetic stainless steel, a production process of a nonmagnetic stainless steel and a radio wave receiver.

### BACKGROUND ART

A radio-controlled watch is conventionally known which receives a standard frequency and time signal with a bar antenna and corrects the inner time based on timecode included in this received standard frequency and time signal. However, if there is a metallic member having a low electrical resistivity in the neighboring position near the bar antenna, varying magnetic flux of the demagnetizing field generated at the coil of the bar antenna penetrates through the metallic member in the neighboring position to cause loss by eddy current at the time of receiving radio waves, which leads to a problem of deterioration in the receiving sensitivity of the antenna, and therefore, a radio-controlled watch is known in which at least one of the main case and the rear cover of the watch is formed of a nonmetallic member in place of a metallic member. Incidentally, when at least one of the main case and the rear cover of the watch is formed of a nonmetallic material in place of a metallic material, metallic looking or massive feeling is not achieved in the appearance in comparison with a case wherein both the main case and the rear cover are formed of a metallic material and thus the sense of quality or aesthetic appearance needed for accessories is impaired.

For these reasons, a stainless steel, particularly a nonmagnetic austenitic stainless steel (JIS SUS304 or SUS316) has been generally used as a material for either one or both of the main case of a radio-controlled watch and the rear cover attached to the rear side of this main case so that the material may exhibit good appearance and massive feeling. However, the electrical resistivity of JIS SUS304 and SUS316 is 70 μΩ·cm at most and when these stainless steels are used as materials of the main case and the rear cover, low electrical resistivity may deteriorate the radio wave receiving sensitivity of the radio-controlled watch. Therefore, as the stainless steels to use as members such as the main case or the rear cover of a radio-controlled watch, materials having a higher electrical resistivity than SUS304 and SUS316 are demanded while maintaining nonmagnetic properties.

As a stainless steel having nonmagnetic properties and high resistivity, a stainless steel described in Japanese Patent Laid-Open No. 2003-41349 (Patent Document 1) is suggested. The nonmagnetic stainless steel suggested in this Patent Document 1 improves electrical resistivity up to 100 μΩ·cm at the maximum by adjusting alloy elements.

In the meantime, in order to achieve a sufficient receiving sensitivity when both the main case and the rear cover of a watch are formed of a metallic material, a radio-controlled watch having a construction wherein a recessed part is formed in the inner peripheral surface of the main case and the rear cover which face the antenna and a nonmagnetic member is disposed in this recessed part has been proposed, for example, in Japanese Patent Laid-Open No. 2006-275580 (Patent Document 2).

This Patent Document 2 discloses a case structure of a radio-controlled timepiece comprising a main case which contains an antenna and a timepiece device and a rear cover wherein a recessed part is formed on the inner side of at least one of the main case and the rear cover and a nonmagnetic member whose electrical resistivity is set to below 7.0 μΩ·cm is engaged in this recessed part. In addition, there is described in Patent Document 2 that the main case or the rear cover is composed of at least one of carbide and tantalum carbide.

### PRIOR ART DOCUMENTS

### Patent Document

Patent Document 1: Japanese Patent Laid-Open No. 2003-41349

Patent Document 2: Japanese Patent Laid-Open No. 2006-275580

### SUMMARY OF THE INVENTION

### Problems to be Solved by the Invention

The electric resistance material disclosed in the above stated Patent Document 1 has an electrical resistivity as high as 100 μΩ·cm higher than SUS304 and SUS316 but the electrical resistivity of 100 μΩ·cm is an electrical resistivity which is equal to JIS SUSXM15J1 and makes a little difference from existing high Si austenitic stainless steels.

In addition, the case structure of a radio-controlled timepiece disclosed in Patent Document 2 disposes a nonmagnetic member in the recessed part formed in the inner peripheral surface of the timepiece case and the rear cover which faces the antenna and therefore has problems that it incurs production cost and results in increase in the number of parts to use. Beside, since the electrical resistivity of the nonmagnetic member disposed in the recessed part was low, the structure has a problem that the radio wave receiving sensitivity is not sufficient due to this low electrical resistivity.

In the meantime, when a user uses a radio-controlled watch which is a radio wave receiver, the main case and the rear cover are in a condition to contact with the wrist of the human body. On this account, there were problems that nickel (Ni) allergy might occur in some users when they continued to wear a radio-controlled watch whose main case and the rear cover were formed of a metal, particularly a stainless steel, for a long time on the arm or wrist.

Therefore an object of the present invention is to provide a nonmagnetic ‘stainless steel having a further higher electrical resistivity as compared with existing nonmagnetic alloys and enables to achieve a sufficient radio wave receiving sensitivity and prevent occurrence of Ni allergy, a member for a radio-controlled timepiece using the stainless steel, as well as a production process of the nonmagnetic stainless steel and a radio wave receiver.

### Means for solving the problems

As a result of zealously having examined various kinds of alloy elements and the addition amounts thereof so as to achieve coexistence of nonmagnetic properties and a high resistivity in stainless steels, the present inventor has found that addition of Si is effective for the increase of the electrical resistivity. However, since Si is a ferrite phase stabilization element, ferrite phase may be generated and may be magnetized when an amount of Si to enable a high electrical resistivity is added.

Therefore, the present inventor has conducted various kinds of experiments for the optimization of the composition mainly on Ni which is an austenite phase stabilization element and enabled to have an electrical resistivity higher than the alloy disclosed in Patent Document 1 while preventing the occurrence of ferrite phase and maintaining nonmagnetic properties.

In addition, when the nonmagnetic stainless steel according to the present invention is used, for example, as a material for the main case of a radio-controlled watch which is a radio wave receiver and a confinement member blocking up open part of this main case, for example, a rear cover, Ni allergy is worried about as mentioned above and thus it is needed to prevent elution of Ni from the main case materials and the rear cover materials. Therefore, an experiment to find optimization of the alloy composition to prevent Ni elution at the same time has been carried out when incrementation of the Ni content is performed.

The nonmagnetic stainless steel according to the present invention has been obtained as a result of performing the experiment mentioned above. That is, the nonmagnetic stainless steel set forth in claim 1 of the present invention is characterized by consisting of C: not more than 0.1%, Si: 4.0-7.5%, Mn: not more than 2.0%, Ni: 25.5-30.0%, Cr: 15.0-20.0%, Mo: 0.1-3.0%, Cu: 0-2.0%, in mass % and the balance Fe and impurities. In addition, the nonmagnetic stainless steel set forth in claim 2 is directed to the nonmagnetic stainless steel according to claim 1 characterized by containing Si: 4.0-5.8% in mass %. Furthermore, the invention set forth in claim 3 is directed to the nonmagnetic stainless steel according to claim 1 characterized by having an electrical resistivity of more than 100 μΩ·cm.

In addition, the invention set forth in claim 4 is directed to a member for a radio-controlled timepiece which is made of a nonmagnetic stainless steel according to claim 1.

In addition, the invention set forth in claim 5 is directed to a member for a radio-controlled timepiece according to claim 4, wherein the member for the radio-controlled timepiece is characterized by being a member for at least a main case, a rear cover, a bezel member, a dial plate, a boundary member, a part of the above bezel member, an integrally formed main case which is integrally formed of the above main case with the above rear cover.

Furthermore, the invention set forth in claim 6 is directed to a production process of a nonmagnetic stainless steel characterized by subjecting a nonmagnetic stainless steel consisting of C: not more than 0.10, Si: 4.0-7.5%, Mn: not more than 2.0%, Ni: 25.5-30.0%, Cr: 15.0-20.0%, Mo: 0.1-3.0%, Cu: 0-2.0%, in mass % and the balance Fe and impurities to plastic working of hot working and/or cold working followed by solution treatment at 1000-1180° C. In addition, the production process of the nonmagnetic stainless steel set forth in claim 7 is directed to a production process of a nonmagnetic stainless steel according to claim 6 which is characterized by containing Si: 4.0-5.8% in mass %.

Furthermore, the invention set forth in claim 8 is directed to a radio wave receiver characterized in that the radio wave receiver has a main case and an antenna for receiving radio waves disposed in the main case and the main case is formed of a nonmagnetic stainless steel according to claim 1.

In addition, the invention set forth in claim 9 is directed to a radio wave receiver characterized in that the radio wave receiver has a cylindrical main case, a confinement member blocking up open part of the cylindrical main case and an antenna for receiving radio waves disposed in the main case and the main case and the confinement member are formed of a nonmagnetic stainless steel according to claim 1.

In addition, the invention set forth in claim 10 is directed to a radio wave receiver characterized in that the radio wave receiver has a cylindrical main case, a confinement member blocking up open part of the cylindrical main case, a bezel member disposed between the confinement member and the main case and an antenna for receiving radio waves disposed in the main case and a part or whole of the main case, the confinement member and the bezel member are formed of a nonmagnetic stainless steel according to claim 1.

### Advantageous Effects of the Invention

According to the present invention, a nonmagnetic stainless steel having a high electrical resistivity and a very little Ni elution can be obtained. In addition, according to the nonmagnetic stainless steel of the present invention, the receiving sensitivity of the radio wave can be greatly improved as compared with SUS304 and SUS316 used conventionally as well as occurrence of Ni allergy can be prevented.

On this account, it is extremely useful as a material for constitution members of a radio wave receiver such as, for example, a main case, a rear cover serving as a confinement member or a bezel member, a dial plate, and a boundary member of a radio-controlled watch.

### BRIEF DESCRIPTION OF THE DRAWINGS

FIG. 1 is a section micrograph of a nonmagnetic stainless steel after subjected to solution treatment which illustrates an example of the present invention.

FIG. 2 is a section micrograph of a nonmagnetic stainless steel after subjected to solution treatment which illustrates another example according to the present invention.

FIG. 3A is a perspective view illustrating a radio-controlled watch to which the radio wave receiver of the present invention is applied and obliquely viewed from the front side.

FIG. 3B is a perspective view illustrating the radio-controlled watch shown in FIG. 3A obliquely viewed from the rear side.

FIG. 4 is a partly omitted cross section illustrating the inner structure of the radio-controlled watch of FIG. 3A.

FIG. 5A is a perspective view illustrating another radio-controlled watch to which the radio wave receiver of the present invention is applied and obliquely viewed from the front side.

FIG. 5B is a perspective view illustrating the radio-controlled watch shown in FIG. 5A obliquely viewed from the rear side.

FIG. 6 is a partly omitted cross section illustrating the inner structure of the radio-controlled watch of FIG. 5A.

FIG. 7 is a partly omitted cross section illustrating the inner structure of the radio-controlled watch shown in FIG. 4 when the dial plate of this radio-controlled watch is displayed.

FIG. 8 is a partly omitted cross section illustrating the inner structure of the radio-controlled watch shown in FIG. 6 when the dial plate of this radio-controlled watch is displayed.

### MODE FOR CARRYING OUT THE INVENTION

At first, the nonmagnetic stainless steel according to the present invention is described. The important characteristic of the nonmagnetic stainless steel of the present invention is that the electrical resistivity is increased while maintaining a nonmagnetic austenite phase as stated above. In the nonmagnetic stainless steel of the present invention, reasons for prescribing the respective chemical composition in the following ranges are as follows. Here, description is made in terms of mass % unless otherwise indicated in the following description.

C: not more than 0.1%

C is a powerful austenite phase stabilization element, but when C is present surpassing 0.1%, carbide with Cr becomes easy to occur and as a result Cr around the resulted Cr carbide tends to be deficient, and thereby grain boundary corrosion becomes easy to occur. Therefore the upper limit is set to 0.1%. A preferable upper limit of C is 0.05% and more preferably not more than 0.03%. No addition thereof is allowed.

Si: 4.0-7.5%

Si is an important element having an effect to increase electrical resistivity, and content not less than 4.0% is necessary. However, hot working characteristics deteriorate when Si exceeds 7.5%. Furthermore, the addition of the Si is effective in lowering a melting point, and the melting point falls to a temperature at which hot working becomes impossible by adding a content more than 7.5%. In addition, since Si is a ferrite phase stabilization element, there is caused a problem that the ferrite phase is generated so that the steel may be magnetized when Si is added in a content more than 7.5% and thus the range of Si is set to 4.0-7.5%. A preferable upper limit of Si is 7.0%.

In addition, intermetallic compounds containing Si precipitate as the addition amount of Si increases, and thus workability deteriorates unless an appropriate heat treatment is performed. The range that can control the precipitation of these intermetallic compounds more surely is 4.0-5.8%.

In addition, a preferable lower limit to surely obtain the effect to increase the electrical resistivity possessed by Si is 4.5%.

Mn: not more than 2.0%

Mn is an element which stabilizes austenite phase and is effective for non-magnetization, but when it is added excessively, mechanical properties such as impact strength and tensile ductility deteriorate and thus the upper limit is set to 2.0%. A preferable upper limit of Mn is 1.0%.

Ni: 25.5-30.0%

Ni is an element which stabilizes austenite phase and is effective for non-magnetization. 25.5% is necessary as the lower limit of Ni in order to surely obtain the effect to stabilize the austenite phase by the addition of Ni. However, the upper limit is set to 30.0% since Ni elution becomes easy to occur when Ni is added excessively. A preferable upper limit of Ni is 29.0%, and a preferable lower limit is 27.0%.

Cr: 15.0-20.0%

Cr is an important element which improves corrosion resistance and prevents Ni elution, and 15.0% is necessary to sufficiently secure corrosion resistance by the addition of Cr. However, since Cr is a ferrite phase stabilization element, excessive addition thereof destabilizes the austenite phase and inhibits non-magnetization and thus the upper limit was set to 20.0%. A preferable upper limit of Cr is 19.0%, and a preferable lower limit is 17.0%.

Mo: 0.1-3.0%

Mo is an important element which improves corrosion resistance and prevents Ni elution, and it is necessary to add Mo even in a minimum amount. Therefore the necessary lower limit of Mo is set to not less than 0.1%. However, since Mo is a ferrite phase stabilization element, excessive addition thereof destabilizes the austenite phase and inhibits non-magnetization and thus the upper limit was set to 3.0%. A preferable upper limit of Mo is 2.0%, more preferably 1.2%. In addition, a preferable lower limit of Mo to secure the effect of preventing Ni elution is 0.4%, more preferably 0.8%.

Cu: 0-2.0%

Cu is an element which improves corrosion resistance and prevents Ni elution and may be added in the range of 0% (not added) −2.0% as needed. However, the upper limit of Cu is 2.0% since excessive addition thereof deteriorates hot working properties. A preferable upper limit of Cu is 1.0%, more preferably 0.7%. In addition, it is preferable to set the lower limit of 0.3% in order to secure the effect of preventing Ni elution by the addition of Cu.

Balance Fe and Impurities

In the present invention, the other elements than those mentioned above are Fe and impurities. The less the contents of impurities are, the more preferable, but they may be contained as long as the contents are in the following range as the range which does not deteriorate hot working properties and tenacity.

P≦0.05%, S≦0.05%, N≦0.1%, Al≦0.5%

By the chemical composition mentioned above of nonmagnetic stainless steel according to the present invention, electrical resistivity can surpass 100 μΩ·cm. Due to this high electrical resistivity, receiving sensitivity of radio wave of a radio-controlled watch can be improved by using these nonmagnetic stainless steels when they are, for example, used as parts (main case, confinement members such as rear cover blocking up the open parts of the main case) for radio-controlled watches.

In addition, higher electrical resistivity is preferable when the nonmagnetic stainless steel according to the present invention is used as parts for radio-controlled watches. Preferable electrical resistivity is not less than 110 μΩ·cm, more preferably not less than 115 μΩ·cm.

Next, the production process of a nonmagnetic stainless steel according to the present invention is described.

The production process of the nonmagnetic stainless steel of the present invention may employ ordinary methods for the steps from ingot making, forging, to the hot working and/or cold working such as metal rolling, but management of solution treatment temperature after plastic working of the hot working and/or cold working is effective.

Since the nonmagnetic stainless steels prescribed by the present invention stated above contains a large amount of alloying elements, intermetallic compounds except for the austenite phase may occur during the production process of the present alloy. When rough intermetallic compounds larger than 10 μm precipitate, pitting corrosion becomes easy to occur, not only elution of Ni becomes easy to occur but also machinability might deteriorate. Therefore, solution treatment at 1000-1180° C. allows the austenite phase to dissolve intermetallic compounds. Thereby pitting corrosion and elution of Ni can be prevented still more.

The reason for setting the lower limit of the solution treatment temperature to 1,000° C. is that intermetallic compounds cannot be dissolved in the austenite phase by the solution treatment below 1,000° C. In the meantime, the reason for setting the upper limit of the solution treatment temperature to 1,180° C. is that melting of the nonmagnetic stainless steel may occur at a temperature higher than 1,180° C. since the present invention contains a large amount of Si, which decreases the melting point. A preferable lower limit of the solution treatment temperature is 1,040° C., and a preferable upper limit of the solution treatment temperature is 1,160° C. Here, the cooling of the solution treatment had better be performed at a cooling rate more than an air-cooling and preferably it is performed by water cooling.

Intermetallic compounds are dissolved in the matrix to obtain a homogeneous austenite phase by performing the solution treatment mentioned above after the plastic working of hot working and/Or cold working. Thereby an effect for preventing pitting corrosion is resulted. In addition, an effect for facilitating machining can be obtained since the machinability improves by the decrease of the hardness due to the solution treatment. Here, the above effect can be sufficient obtained as long as the duration time for the solution treatment is from one minute to ten hours.

### EXAMPLES

The nonmagnetic stainless steels according to the present invention are described in detail based on the results of those experimentally produced.

Table 1 shows chemical compositions of the nonmagnetic stainless steel of the present invention (Nos. 1-10) and the chemical compositions (Nos. 11-16) of alloys which are comparative examples.

Ingots having a weight of 10 kg were prepared by vacuum induction melting, and then subjected to hot working which were forging and hot rolling to obtain nonmagnetic stainless steels having a thickness of 20 mm and a width of 80 mm (Nos. 1 to 8 shown in Table 1) and comparative alloys (Nos. 11 to 16 shown in Table 1). Chemical compositions of the prepared 10 kg nonmagnetic stainless steels and 10 kg comparative alloys are shown in Table 1.

In addition, ingots having a weight of 200 kg were prepared by vacuum induction melting, and then subjected to hot working which were forging and hot rolling to obtain nonmagnetic stainless steels having a thickness of 15 mm and a width of 200 mm (Nos. 9 and 10). Chemical compositions of the prepared 200 kg nonmagnetic stainless steels are shown in Table 1. Among Comparative Example No. 11 corresponds to a JIS SUS XM15J1 equivalent alloy. Here, “−” shown in Table 1 indicates that addition was not made.

TABLE 1
(mass %)

| No | C | Si | Mn | P | S | Ni | Cr | Mo | Cu | N | Balance | Remarks |
|---|---|---|---|---|---|---|---|---|---|---|---|---|
| 1 | 0.03 | 6.47 | 0.47 | 0.026 | 0.002 | 27.86 | 18.19 | 0.51 | 0.43 | 0.0022 | Fe and | Present |
| | | | | | | | | | | | Inevitable | Invention |
| | | | | | | | | | | | Impurities | |
| 2 | 0.03 | 6.55 | 0.50 | 0.027 | 0.002 | 27.77 | 18.22 | 1.00 | 0.43 | 0.0019 | Same as above | |
| 3 | 0.01 | 6.53 | 0.47 | 0.027 | 0.002 | 27.81 | 18.18 | 1.03 | 0.43 | 0.0015 | Same as above | |
| 4 | 0.03 | 6.09 | 0.44 | 0.029 | 0.002 | 28,03 | 18.05 | 2.02 | — | 0.0017 | Same as above | |
| 5 | 0.03 | 5.91 | 0.47 | 0.029 | 0.002 | 27.93 | 18.30 | 2.01 | 0.43 | 0.0013 | Same as above | |
| 6 | 0.01 | 5.91 | 0.44 | 0.028 | 0.001 | 27.62 | 17.84 | 1.00 | 0.44 | 0.0025 | Same as above | |
| 7 | 0.01 | 5.49 | 0.47 | 0.028 | 0.001 | 27.83 | 18.01 | 1.00 | 0.44 | 0.0020 | Same as above | |
| 8 | 0.01 | 4.9 | 0.47 | 0.024 | 0.001 | 27.85 | 17.66 | 0.96 | 0.48 | 0.0021 | Same as above | |
| 9 | 0.01 | 6.48 | 0.50 | 0.004 | 0.001 | 27.84 | 17.78 | 1.02 | 0.50 | 0.0053 | Same as above | |
| 10 | 0.01 | 6.15 | 0.50 | 0.004 | 0.001 | 27.83 | 17.98 | 0.97 | 0.50 | 0.0030 | Same as above | |
| 11 | — | 4.05 | 0.50 | — | 0.002 | 13.57 | 17.94 | — | — | 0.0014 | Same as above | Comparative |
| 12 | — | 5.09 | 0.52 | — | 0.002 | 13.57 | 17.93 | — | — | 0.0022 | Same as above | Examples |
| 13 | 0.02 | 0.94 | 1.97 | 0.022 | 0.002 | 24.95 | 21.10 | 3.93 | 1.50 | 0.0012 | Same as above | |
| 14 | 0.03 | 6.1 | 0.49 | 0.029 | 0.002 | 24.56 | 15.39 | — | — | 0.0014 | Same as above | |
| 15 | 0.03 | 6.61 | 0.50 | 0.028 | 0.001 | 27.88 | 15.93 | — | — | 0.0017 | Same as above | |
| 16 | 0.001 | 3.04 | 0.49 | 0.003 | 0.002 | 13.45 | 17.85 | — | — | 0.0013 | Same as above | |

* “—” shown in Table 1 indicates that addition was not made.

The prepared nonmagnetic stainless steels and comparative alloys were subjected to solution heat treatment by maintaining them at solution treatment temperatures shown in Table 2 for one hour followed by water cooling. Then, sample pieces of 4 mm×4 mm×80 mm for measuring electrical resistivity, circular sample pieces of 10 mm(thickness)×20 mm(diameter) for measuring magnetic characteristics and sample pieces of 5 mm(thickness)×20 mm(length)×20 mm(width) for immersing in artificial sweat were prepared and measurement of electrical resistivity, measurement of relative permeability and Ni elution test to immerse them in artificial sweat for one week were performed. The results are shown in Table 2.

Here, the Ni elution test employs an artificial sweat solution prepared of 0.5% NaCl+0.1% lactic acid+0.1% urea and adjusted to pH 6.5 with ammonium in which the sample pieces were immersed for one week while adjusting the maintenance temperature and the range around it to 30° C.±2° C. The artificial sweat solutions after the test and the artificial sweat solutions not used in the tests were analyzed and Ni elution amount was determined from the differences of the amounts of Ni. It is said that if the Ni elution amount is not less than 5 μg/cm²/week, the material cannot be used as a frame material for a radio-controlled watch.

In Table 2, results with a Ni elution amount of less than 5 μg/cm²/week are marked with a circle (∘) and results with a Ni elution amount of not less than 5 μg/cm²/week are marked with a cross (×).

In addition, among those found to be ferromagnetic in the measurement of relative permeability and alloys with an electrical resistivity of less than 100 μΩ·cm, those not subjected to the Ni elution test were marked with “not tested”.

TABLE 2

| | Solution | | | Ni elution after | |
|---|---|---|---|---|---|
| | treatment | Electrical | Relative | the artificial | |
| Alloy | temperature | resistivity | permeability | sweat test for | |
| No. | (° C.) | (μΩ · cm) | (μr) | one week | Remarks |
| 1 | 1050 | 121.0 | 1.004 | ◯ | Present invention |
| 1 | 1150 | 121.0 | 1.004 | ◯ | Present invention |
| 2 | 1050 | 121.0 | 1.004 | ◯ | Present invention |
| 2 | 1100 | 122.0 | 1.004 | ◯ | Present invention |
| 2 | 1150 | 120.8 | 1.004 | ◯ | Present invention |
| 3 | 1050 | 122.0 | 1.004 | ◯ | Present invention |
| 3 | 1100 | 121.3 | 1.004 | ◯ | Present invention |
| 3 | 1150 | 120.7 | 1.003 | ◯ | Present invention |
| 4 | 1050 | 120.6 | 1.004 | ◯ | Present invention |
| 4 | 1100 | 120.0 | 1.004 | ◯ | Present invention |
| 4 | 1150 | 120.5 | 1.004 | ◯ | Present invention |
| 5 | 1050 | 121.8 | 1.004 | ◯ | Present invention |
| 5 | 1100 | 119.8 | 1.004 | ◯ | Present invention |
| 5 | 1150 | 119.2 | 1.003 | ◯ | Present invention |
| 6 | 1100 | 117.5 | 1.004 | ◯ | Present invention |
| 6 | 1150 | 117.6 | 1.004 | ◯ | Present invention |
| 7 | 1100 | 115.2 | 1.004 | ◯ | Present invention |
| 7 | 1150 | 115.3 | 1.004 | ◯ | Present invention |
| 8 | 1100 | 112.2 | 1.004 | ◯ | Present invention |
| 8 | 1150 | 113.9 | 1.004 | ◯ | Present invention |
| 9 | 1150 | 120.7 | 1.004 | ◯ | Present invention |
| 10 | 1150 | 118.6 | 1.004 | ◯ | Present invention |
| 11 | 1050 | 96.9 | 1.006 | Not conducted | Comparative Example |
| 12 | 1050 | 104.6 | Ferromagnetic | Not conducted | Comparative Example |
| | | | (not less than 4) | | |
| 13 | 1050 | 97.0 | 1.004 | Not conducted | Comparative Example |
| 14 | 1050 | 111.3 | 1.005 | X | Comparative Example |
| 15 | 1050 | 118.2 | 1.005 | X | Comparative Example |
| 16 | 1050 | 90.7 | 1.005 | Not conducted | Comparative Example |

From the results shown in Table 2, it can be understood that the nonmagnetic stainless steels of the present invention are compatible both in nonmagnetic properties and high electrical resistivity. In particular, it can be understood that the value of the electrical resistivity increases when the Si content increases and a preferable electrical resistivity as high as not less than 110 μΩ·cm was attained in No. 8 in which Si content was a little low.

From this, in order to attain not less than 110 μΩ·cm which is a preferable electrical resistivity, it is necessary to use a nonmagnetic stainless steel having a high electrical resistivity of the present invention and set the lower limit of the Si content to around 4.5%. It can be also understood that the nonmagnetic stainless steels produced by the production process of the present invention are excellent in corrosion resistance while elution of Ni is not observed.

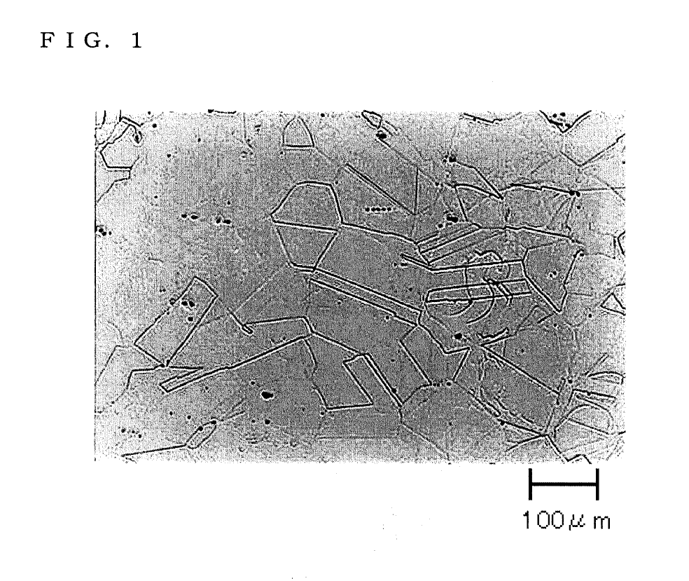

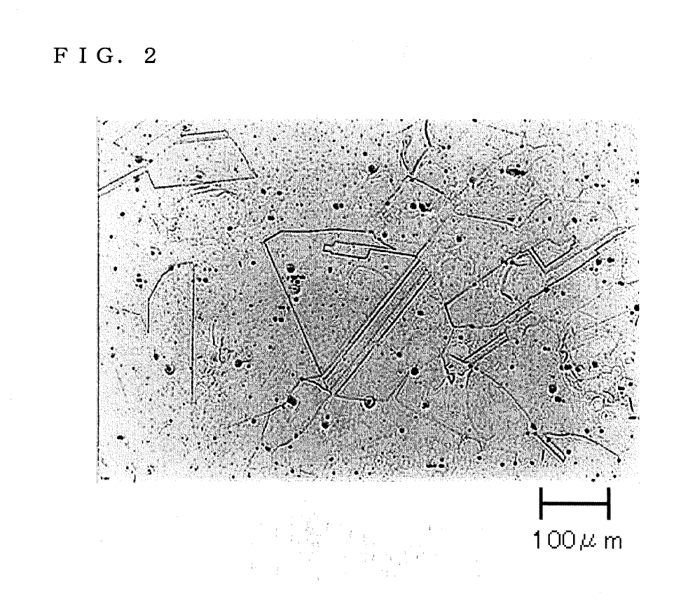

Next, of the nonmagnetic stainless steels after the solution treatment stated above, a section micrograph of No. 8 in which Si content was set to 4.90% was shown in FIG. 1 and a section micrograph of No. 6 in which Si content was set to 5.91% was shown in FIG. 2. Minute specks shown in FIG. 1 and FIG. 2 indicate intermetallic compounds. It can be understood from these section micrographs that the amount of precipitation of intermetallic compounds is lower and the size thereof is smaller in No. 8 alloy with a low Si content as compared with No. 6 alloy. In addition, the section micrographs shown in FIG. 1 and FIG. 2 show the cases wherein the temperature of solution treatment was 1,150° C. respectively.

In the following, a mode of the embodiment according to the present invention wherein the radio wave receiver of the present invention was applied to a radio-controlled watch.

### First embodiment

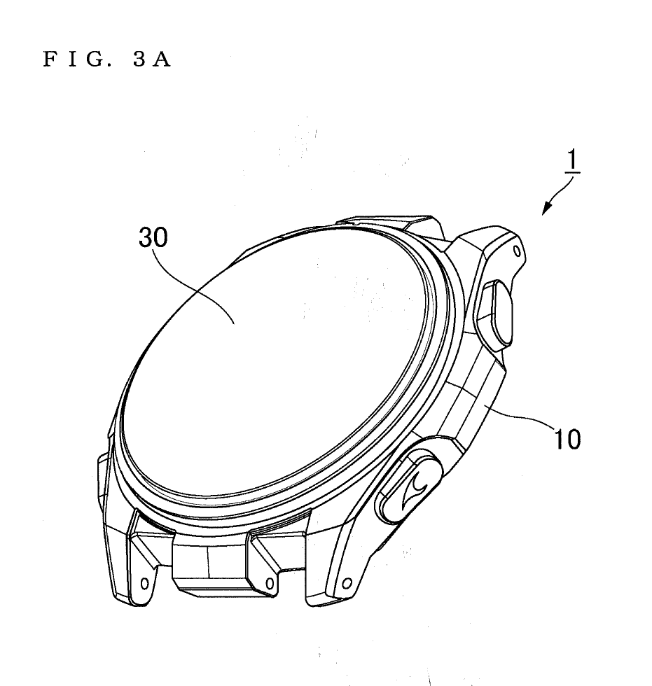

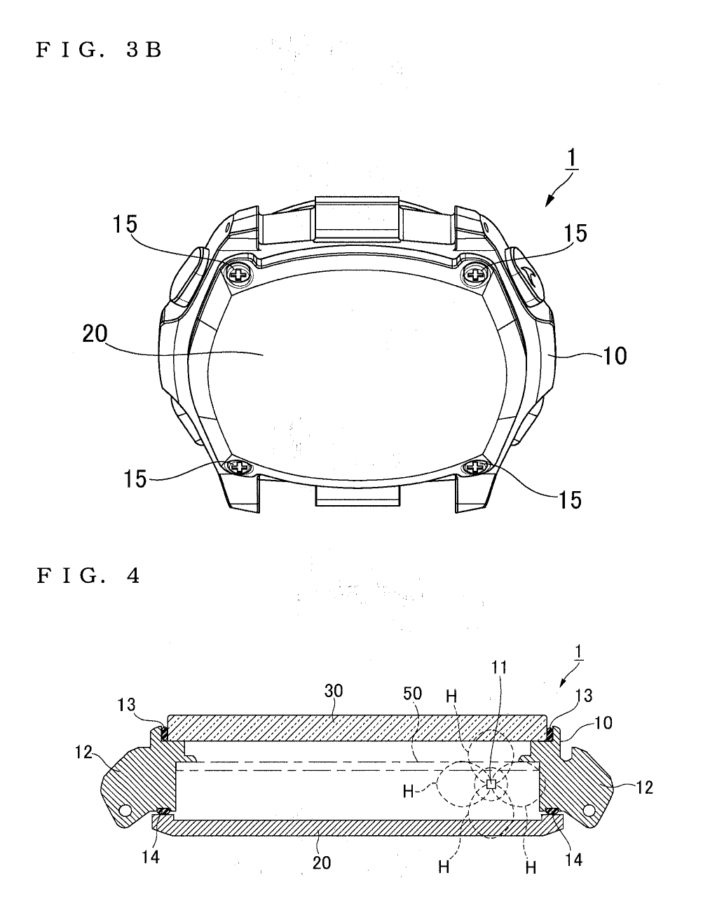

FIG. 3A and FIG. 3B show a radio-controlled watch according to the first embodiment for a radio wave receiver of the present invention, and FIG. 3A is a perspective view illustrating the radio-controlled watch obliquely viewed from the front side, and FIG. 3B is a perspective view illustrating the radio-controlled watch obliquely viewed from the rear side. FIG. 4 is a partly omitted cross section illustrating the inner structure of the radio-controlled watch of FIG. 3A (FIG. 3B).

Here, FIG. 4 is illustrated with timepiece module and electronic parts disposed in the main case being removed so that the inner structure of the radio-controlled watch may be easily understood.

A radio-controlled watch 1 which receives the standard frequency and time signal and corrects the time consists of various parts (hereinbelow referred to as “parts for radio-controlled timepiece”) for use in a radio-controlled timepiece as shown in FIG. 3A, FIG. 3B and FIG. 4. For example, it has a cylindrical main case 10, a rear cover 20 which is a confinement member for the opening at one end side of the cylindrical main case 10 to block up the opening at one end side, and a timepiece glass 30 which is a confinement member for the opening at the other end side of the cylindrical main case 10 to block up the opening at the other end side, etc.

Furthermore, the cylindrical main case 10 has timepiece modules (not illustrated) disposed inside and electronic parts such as a dial plate 50 and an antenna 11 for receiving radio waves, and the main case protects these parts from external shocks.

The radio wave receiver of the present invention is characterized in that parts for a radio-controlled timepiece (hereinbelow referred to as “members for a radio-controlled timepiece”) formed of a nonmagnetic stainless steel according to the present invention is used for parts affecting radio wave receiving sensitivity or parts for which occurrence of Ni allergy by the elution of Ni should be prevented when the present invention is carried out as a radio-controlled watch among the parts for radio-controlled timepiece.

The main case 10 is formed of a nonmagnetic stainless steel according to the present invention mentioned above. That is, this nonmagnetic stainless steel consists of C: not more than 0.1%, Si: 4.0-7.5%, Mn: not more than 2.0%, Ni: 25.5-30.0%, Cr: 15.0-20.0%, Mo: 0.1-3.0%, Cu: 0-2.0%, balance Fe and impurities in mass % (see, for example, No. 3 shown in Table 1).

In addition, this nonmagnetic stainless steel has an electrical resistivity more than 100 μΩ·cm, for example, an electrical resistivity of not less than 110 μΩ·cm, preferably an electrical resistivity of not less than 115 μΩ·cm.

The rear cover 20 is formed of a nonmagnetic stainless steel according to the present invention like the main case 10. This rear cover 20 is fixed with four screws 15, 15 on the lower side of main case 10.

In addition, protruded parts 12 (see FIG. 4) which protrude to the outer side are formed at parts facing the time characters 12 and 6 in the main case 10, and band members (not illustrated) can be attached these protruded parts 12 so that the radio-controlled watch 1 can be mounted on the arm (wrist) of the user.

In the central part on the top surface of the main case 10, a timepiece glass 30 is mounted via a ring-shaped packing 13. In addition, a waterproofing ring 14 is provided between the main case 10 and the rear cover 20 to secure airtightness within the main case 10.

A surface treatment film layer (not illustrated) such as a plating layer or a decoration layer for use in decoration is formed on the surfaces of the main case 10 and the rear cover 20, but this surface treatment film layer or decoration layer for use in decoration are not necessarily to be formed on the surfaces of the main case 10 and the rear cover 20.

The main case 10 and the rear cover 20 as mentioned above are members 100 (see FIG. 7) for a radio-controlled timepiece formed of a nonmagnetic stainless steel of the present invention.

The antenna 11 for receiving radio waves is in the form of a bar antenna and has a bar-like core formed of a magnetic material having a high relative permeability and a small conductivity such as amorphous or ferrite and has a coil in which conducting wires such as those made of copper are wound around the outer peripheral of the central part of this core.

When this antenna 11 is placed in a magnetic field of a radio wave transmitted from the outside, magnetic flux by this magnetic field will converge on the core having a higher relative permeability than the circumference space, and the magnetic flux, which is a demagnetizing field, generates at the coil wound around the outer peripheral of the central part of this core in such a direction as to prevent change of the flux inside the coil, and thus an induced electromotive force hereby generates.

Based on the timecode which is time data included in the electric signal of the induced electromotive force which has occurred at this coil, the timekeeping time by the timekeeping circuit is corrected.

Incidentally, magnetic flux H shown with dashed lines in FIG. 4 is generated around the coil of the antenna 11 when a radio wave is received, but when there is a metallic member having a low electrical resistivity at a neighboring position near the coil, a part of varying magnetic flux H which is generated from the coil goes through the metallic member and generates an eddy current there.

When such an eddy current is generated, the magnetic field energy at the time of the resonance of the coil is lost as eddy current loss, which results in the loss of the antenna coil and thus deterioration of the receiving efficiency of antenna 11 is caused by that amount.

However, in the case of this embodiment, the main case 10 and the rear cover 20 are formed of a nonmagnetic stainless steel according to the present invention having a high electrical resistivity exceeding 100 μΩ·cm, for example, electrical resistivity of not less than 110 μΩ·cm, preferably not less than 115 μΩ·cm.

On this account, when a part of varying magnetic flux H which is generated at the coil penetrates through both of the main case 10 and the rear cover 20, eddy current loss is greatly reduced and deterioration of the receiving efficiency of antenna 11 due to the eddy current loss can be obviated.

As a result, sufficient radio wave receiving sensitivity can be obtained.

In addition, the main case 10 and rear cover 20 is formed of a nonmagnetic stainless steel according to the present invention in which elution of Ni is suppressed, and therefore, even when a radio-controlled watch 1 is worn on the arm or wrist and this arm or wrist on which the watch is worn and the main case 10 or the rear cover 20 are contacted with each other, occurrence of Ni allergy in a human body such as arm or wrist by the contact can be prevented.

### Second Embodiment

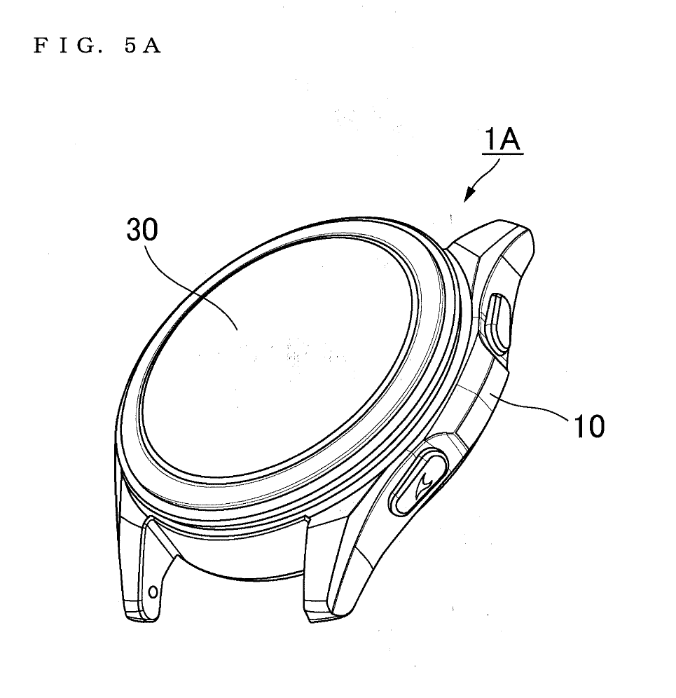

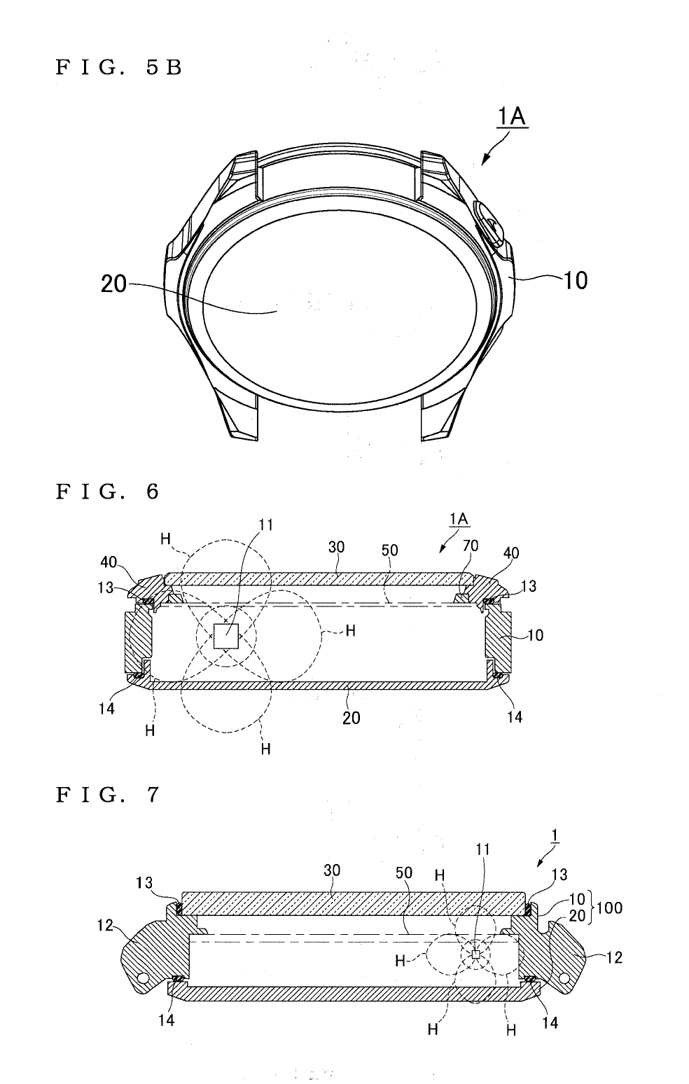

FIG. 5A, FIG. 5B and FIG. 6 show a radio-controlled watch according to the second embodiment about a radio wave receiver of the present invention, and FIG. 5A is a perspective view illustrating the radio-controlled watch obliquely viewed from the front side, and FIG. 5B is a perspective view illustrating the radio-controlled watch obliquely viewed from the rear side.

In addition, FIG. 6 is a partly omitted cross section illustrating the inner structure of the radio-controlled watch. Here, FIG. 6 is illustrated with timepiece module and electronic parts disposed in the main case being removed so that the inner structure of the radio-controlled watch may be easily understood like in the case of FIG. 4.

In the second embodiment shown in FIG. 5A, FIG. 5B and FIG. 6, the same constitution members are referred to by the same reference number in the drawings as in the case of the first embodiment shown in FIG. 3A, FIG. 3B and FIG. 4 and the description thereof is omitted.

In the case of this second embodiment, the watch 1A has a cylindrical main case 10, rear cover 20 which is a confinement member for the opening at one end side of the cylindrical main case 10 to block up the opening at one end side, and a timepiece glass 30 which is a confinement member for the opening at the other end side of the cylindrical main case 10 to block up the opening at the other end side, etc. and further, an annular bezel member 40 disposed between the other end of the above cylindrical main case 10 and the above timepiece glass 30.

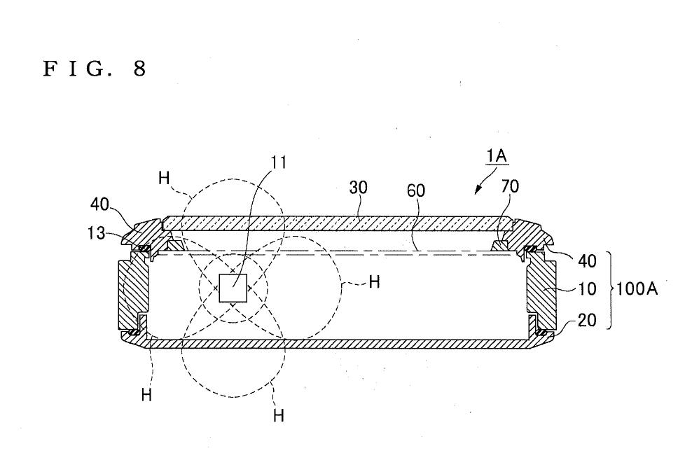

The main case 10, the rear cover 20 and the annular bezel member 40 are formed of a nonmagnetic stainless steel which is a similar material as for the main case 10 and the rear cover 20 in the first embodiment shown in FIG. 1 and FIG. 2. Here, the bezel member 40 is a annular member to decorate the outer surface of the main case 10. The main case 10, the rear cover 20 and the bezel member 40 mentioned above constitute a radio-controlled timepiece member 100A (see FIG. 8) formed of a nonmagnetic stainless steel of the present invention.

In the radio-controlled watch shown in this second embodiment, magnetic flux H shown with dashed lines in FIG. 6 is generated at the coil of the antenna 11 when a radio wave is received, but he main case 10, the rear cover 20 and the bezel member 40 which constitute a radio-controlled timepiece member is formed of a nonmagnetic stainless steel having a high electrical resistivity more than 100 μΩ·cm.

On this account, when a part of magnetic flux H which is generated at the coil respectively flows into the main case 10, the rear cover 20 and the bezel member 40, deterioration of the receiving efficiency of antenna 11 due to the eddy current loss can be obviated and as a result, sufficient radio wave receiving sensitivity can be attained. In addition, since the main case 10, the rear cover 20 and the bezel member 40 are formed of a nonmagnetic stainless steel according to the present invention in which elution of Ni is suppressed, occurrence of Ni allergy can be also prevented.

### Third Embodiment

Cases wherein a nonmagnetic stainless steel of the present invention having a high electrical resistivity is used as a material for forming the main case 10, the rear cover 20 and the bezel member 40 of a radio-controlled watch which constitute a radio-controlled timepiece member are described in the first and the second embodiments mentioned above, but besides these members, the other metallic members placed in the main case of a radio-controlled watch, for example, the dial plate 50 and the boundary member 70 disposed in the peripheral of this dial plate 50 may be formed of a nonmagnetic stainless steel of the present invention having a high electrical resistivity as a radio-controlled timepiece member 100 (100A) so that further sufficient radio wave receiving sensitivity may be attained.

FIG. 7 shows a case wherein the whole of dial plate which a radio-controlled watch showing the first embodiment (see FIG. 4) has is formed of a dial plate 50 consisting of a nonmagnetic stainless steel of the present invention.

Likewise, FIG. 8 shows a case wherein the whole of dial plate 50 which a radio-controlled watch showing the second embodiment (see FIG. 6) has is formed of a dial plate 60 consisting of a nonmagnetic stainless steel of the present invention. In addition, FIG. 8 shows a boundary member 70 which is formed of a nonmagnetic stainless steel of the present invention and disposed on the top surface of dial plate 60 in the peripheral part of the dial plate 60.

The main case 10, the rear cover 20, the dial plate or 60, and the boundary member 70 constituting the members for a radio-controlled timepiece are formed of a nonmagnetic stainless steel having a high electrical resistivity more than 100 μΩ·cm as shown in FIG. 7 and FIG. 8.

On this account even if a part of magnetic flux H which is generated at the coil respectively flows into the main case 10, the rear cover 20, the dial plate 50 or 60 and the boundary member 70, deterioration of the receiving efficiency of antenna 11 due to the eddy current loss can be obviated and as a result, sufficient radio wave receiving sensitivity can be attained.

In addition, since the main case 10, the rear cover 20, the dial plate 50 or 60 and the boundary member 70 are formed of a nonmagnetic stainless steel of the present invention in which elution of Ni is suppressed, occurrence of Ni allergy can be prevented.

Incidentally, as for the dial plate 50 or 60 constituting members for these radio-controlled timepieces, a similar effect can be exhibited even if not the whole but a part thereof or the respective time characters from 1 to 12 are formed of a nonmagnetic stainless steel according to the present invention.

As shown in FIG. 7 and FIG. 8, since an antenna 11 is disposed just below the dial plate 50 or 60 but the whole or a part of the dial plate 50 or 60 is formed of a nonmagnetic stainless steel according to the present invention mentioned above, deterioration of the receiving efficiency of antenna 11 due to the eddy current loss can be prevented as mentioned above.

### Trial Production Example

As a member for a radio-controlled timepiece made of a nonmagnetic stainless steel of the present invention, a radio-controlled watch comprising a main case, a rear cover and a bezel member was produced experimentally and the receiving sensitivity of the standard frequency and time signal and Ni allergy occurrence were measured. In the following, the trial production of this radio-controlled watch and the results of the measurement are described.

In this trial production, all of the main case, the rear cover and the bezel member constituting the member for a radio-controlled timepiece were produced of a nonmagnetic stainless steel according to the present invention, which is the No. 3 alloy shown in Table 1 by press-forming processing, etc.

Here, in the production of this nonmagnetic stainless steel, the temperature of solution treatment was performed at 1,150° C. And a transmitter which transmitted the standard frequency and time signal including the time cord was installed at a position with a predetermined distance away from the experimentally produced radio-controlled watch and this standard frequency and time signal was received with the antenna in the experimentally produced radio-controlled watch and the receiving sensitivity was measured.

Here, in this measurement, receiving sensitivity of the radio wave was measured for a conventional radio-controlled watch comprising a main case, a rear cover and a bezel member formed of a stainless steel, SUS304 for comparing with the experimentally produced radio-controlled watch in the same way as above. Here, a dial plate made of a synthetic resin was prepared and incorporated both in the experimentally produced radio-controlled watch and the conventional radio-controlled watch.

As a result of measurement of the receiving sensitivity, it was confirmed that the radio wave receiving sensitivity of the radio-controlled watch comprising the main case, the rear cover and the bezel member constituting members for a radio-controlled timepiece formed of a nonmagnetic stainless steel of the present invention was improved by 0.5-1.9 dEμV/m as compared with a conventional radio-controlled watch. It was able to be revealed that the radio-controlled watch in which the main case, the rear cover and the bezel member which constitute members for a radio-controlled timepiece comprising members formed of a nonmagnetic stainless steel of the present invention has an improved radio wave receiving sensitivity as compared with a radio-controlled watch comprising members for a radio-controlled timepiece formed of conventional SUS304.

In addition, presence/absence of Ni allergy occurrence was tested for the experimentally produced radio-controlled watch comprising the main case, the rear cover and the bezel member as members for a radio-controlled timepiece formed of a nonmagnetic stainless steel of the present invention (alloy No. 3 of the present invention shown in Table 1) mentioned above.

As for the presence/absence of Ni allergy occurrence, carried out was a test as to whether the standard “EU nickel regulation test standard EN1811” (hereinbelow referred to as “EN1811”) (whether the amount of eluting nickel was not more than 0.5 μg/cm²/week when the test product is immersed in artificial sweat for one week (European Directive Annex94/27/EC)) was satisfied or not. As a result of carrying out this test of presence/absence of Ni allergy occurrence, it was able to confirm that “EN1811” was satisfied.

A radio-controlled watch comprising a main case, a rear cover and a bezel member was subjected to the test for the presence/absence of Ni allergy occurrence as members for a radio-controlled timepiece formed of Alloy No. 1 (temperature of solution treatment at 1,150° C.) of the present invention shown in Table 1 likewise. In this test result, it was able to confirm that “EN1811” was satisfied.

In the embodiments of the present invention stated above, description has been made for the radio-controlled watches in which a timepiece module and an antenna are disposed in the main case, but in addition to this kind of radio-controlled watch, the present invention may be applied to radio-controlled watches having a solar battery under the dial plate, radio-controlled watches having a liquid-crystal display panel and radio-controlled watches having indicators for indicating time, etc. Besides, the present invention may be applied to wall hanging radio-controlled clocks or radio-controlled clocks to be placed on the top surface of furniture.

Furthermore, in the embodiments of the present invention stated above, description has been made for the radio-controlled watches in which the whole of the main case, the rear cover and the bezel member are formed of a nonmagnetic stainless steel having a high electrical resistivity of the present invention but a part of the main case, the rear cover and the bezel member of a radio-controlled watch or another type of a radio-controlled timepiece or an integrally formed main case in which the main case and the rear cover are integrally formed may be formed of a nonmagnetic stainless steel having a high electrical resistivity of the present invention.

Here, in the case of such preparation, that is, when a part of the main case, the rear cover and the bezel member of a radio wave receiver is formed of a nonmagnetic stainless steel of the present invention, it is preferable to form, for example, an inner part of the main case which faces the antenna, or at least one opening of one and the other side of the openings, an inner part of the rear cover which faces the antenna, an inner part of the bezel member which faces the antenna using a nonmagnetic stainless steel of the present invention respectively while forming parts other than the above parts using members such as conventional SUS301, SUS316 or titanium, and attach and fix them by an appropriate integrally forming method such as soldering (a kind of welding which is a method for joining metals).

The present invention may be also applied to the other radio wave receivers such as mobile telephones, radio broadcast receivers in addition to the radio-controlled watches mentioned above.

### INDUSTRIAL APPLICABILITY

Since the present invention has a high electrical resistivity and can prevent Ni elution although it is nonmagnetic, and thus it can be widely applied to the uses where coexistence of nonmagnetic properties and high electrical resistivity is necessary. In particular, the present invention is extremely useful as materials of constituting members of radio wave receivers such as radio-controlled watches and mobile telephones.

### DESCRIPTION OF THE MARKS

1, 1A Radio-controlled watch
10 Main case
11 Antenna
20 Rear cover
30 Timepiece glass
40 Bezel member
50, 60 Dial plates
70 Boundary member
100 Member for radio-controlled timepiece
100A Member for radio-controlled timepiece

1. A nonmagnetic stainless steel characterized by consisting of C: not more than 0.1%, Si: 4.0-7.5%, Mn: not more than 2.0%, Ni: 25.5-30.0%, Cr: 15.0-20.0%, Mo: 0.1-3.0%, Cu: 0-2.0%, in mass % and the balance Fe and impurities.

2. The nonmagnetic stainless steel according to claim 1 characterized by containing Si: 4.0-5.8% in mass %.

3. The nonmagnetic stainless steel according to claim 1 characterized by having a high electrical resistivity of more than 100 μΩ·cm.

4. A member for a radio-controlled timepiece characterized by being made of a nonmagnetic stainless steel according to claim 1.

5. The member for a radio-controlled timepiece according to claim 4, wherein the member for the radio-controlled timepiece is characterized by being a member for at least a main case, a rear cover, a bezel member, a dial plate, a boundary member, a part of the above bezel member, an integrally formed main case which is integrally formed of the above main case with the above rear cover.

6. A production process of a nonmagnetic stainless steel characterized by subjecting a nonmagnetic stainless steel consisting of C: not more than 0.1%, Si: 4.0-7.5%, Mn: not more than 2.0%, Ni: 25.5-30.0%, Cr: 15.0-20.0%, Mo: 0.1-3.0%, Cu: 0-2.0%, in mass % and the balance Fe and impurities to plastic working of hot working and/or cold working followed by solution treatment at 1000-1180° C.

7. The production process of a nonmagnetic stainless steel according to claim 6 characterized by containing Si: 4.0-5.8% in mass %.

8. A radio wave receiver characterized in that the radio wave receiver has a main case and an antenna for receiving radio waves disposed in the main case and the main case is formed of a nonmagnetic stainless steel according to claim 1.

9. A radio wave receiver characterized in that the radio wave receiver has a cylindrical main case, a confinement member blocking up open part of the cylindrical main case and an antenna for receiving radio waves disposed in the main case and the main case and the confinement member are formed of a nonmagnetic stainless steel according to claim 1.

10. A radio wave receiver characterized in that the radio wave receiver has a cylindrical main case, a confinement member blocking up open part of the cylindrical main case, a bezel member disposed between the confinement member and the main case and an antenna for receiving radio waves disposed in the main case and a part or whole of the main case, the confinement member and the bezel member are formed of a nonmagnetic stainless steel according to claim 1.
